(19) United States
(12) Patent Application Publication
(10) Pub. No.: US 2026/0024768 A1
(43) Pub. Date: Jan. 22, 2026

(54) SOLID-STATE BATTERY

(71) Applicant: Murata Manufacturing Co., Ltd., Nagaokakyo-shi (JP)

(72) Inventors: Kento HONDA, Nagaokakyo-shi (JP); Yusuke FUNADA, Nagaokakyo-shi (JP)

(21) Appl. No.: 19/339,670

(22) Filed: Sep. 25, 2025

Related U.S. Application Data
(63) Continuation of application No. PCT/JP2023/047055, filed on Dec. 27, 2023.

(30) Foreign Application Priority Data
Mar. 30, 2023 (JP) 2023-055539

(51) Int. Cl. H01M 4/62; H01M 4/02; H01M 4/131; H01M 4/36; H01M 4/525

(52) U.S. Cl. CPC H01M 4/62; H01M 4/131; H01M 4/366; H01M 4/525; H01M 2004/021; H01M 2004/027

(57) ABSTRACT

A solid-state battery including: a negative electrode layer including: a negative electrode active material including a Li composite oxide; and an oxide glass-based solid electrolyte, in which a content percentage of the solid electrolyte is 20% by mass to 60% by mass based on a total amount of the negative electrode active material and the solid electrolyte in the negative electrode layer, and a ratio (B/A) of an actual density B of the negative electrode active material to a true density A of the negative electrode active material is 0.3 to 0.6.

### CROSS REFERENCE TO RELATED APPLICATIONS

The present application is a continuation of International application No. PCT/JP2023/047055, filed Dec. 27, 2023, which claims priority to Japanese Patent Application No. 2023-055539, filed Mar. 30, 2023, the entire contents of each of which are incorporated herein by reference.

### TECHNICAL FIELD

The present disclosure relates to a solid-state battery.

### BACKGROUND ART

Conventionally, secondary batteries that can be repeatedly charged and discharged have been used for various applications. For example, secondary batteries are used as power sources of electronic devices such as smartphones and notebooks.

In a secondary battery, a liquid electrolyte is commonly used as a medium for ion transfer that contributes to charging and discharging. More specifically, a so-called electrolytic solution is used for the secondary battery. However, in such a secondary battery, safety is commonly required in terms of preventing leakage of the electrolytic solution. In addition, because an organic solvent and the like for use in the electrolytic solution are flammable substances, safety is required in that respect as well. Thus, solid-state batteries in which a solid electrolyte is used instead of an electrolytic solution have been studied.
The solid-state battery includes a battery element including a positive electrode layer, a negative electrode layer, and a solid electrolyte interposed between the electrode layers of the positive electrode layer and negative electrode layer. The positive electrode layer includes a positive electrode active material and a solid electrolyte, and the negative electrode layer includes a negative electrode active material and a solid electrolyte.
Patent Document 1: Japanese Patent Application Laid-Open No. 2015-144061
Patent Document 2: Japanese Patent Application Laid-Open No. 2019-77573
Patent Document 3: Japanese Patent Application Laid-Open No. 2020-068188

### SUMMARY OF THE DISCLOSURE

The inventors of the present application have newly found that conventional solid-state batteries have points that can be improved and have a need to take measures therefor.

Specifically, in a solid-state battery, an electrode layer, particularly a negative electrode layer, which is a constituent element of the battery, may be composed of a combination of a negative electrode active material including a Li composite oxide and a garnet-type oxide-based solid electrolyte. However, it is difficult for the garnet-type oxide-based solid electrolyte to form a dense interface with the particles of the negative electrode active material, thereby making it less likely to reduce the porosity in the electrode. This causes the interface resistance between the active material and the solid electrolyte in the negative electrode to be increased, and lithium ions may be made less likely to move across this interface. As a result, there is a possibility that the volume energy density in the solid-state battery may fail to be increased.

The present disclosure has been made in view of such a problem. More specifically, an object of the present disclosure is to provide a solid-state battery including a negative electrode layer capable of reducing the interface resistance between an active material and a solid electrolyte.

To achieve the object mentioned above, an embodiment of the present disclosure provides: a solid-state battery including: a negative electrode layer including: a negative electrode active material including a Li composite oxide; and an oxide glass-based solid electrolyte, in which a content percentage of the solid electrolyte is 20% by mass to 60% by mass based on a total amount of the negative electrode active material and the solid electrolyte in the negative electrode layer, and a ratio (B/A) of an actual density B of the negative electrode active material to a true density A of the negative electrode active material is 0.3 to 0.6.

The solid-state battery according to an embodiment of the present disclosure can provide a negative electrode layer capable of reducing the interface resistance between an active material and a solid electrolyte.

### BRIEF EXPLANATION OF THE DRAWINGS

FIG. 1 is an external perspective view schematically showing a solid-state battery according to an embodiment of the present disclosure.

FIG. 2 is a schematic sectional view of the solid-state battery in FIG. 1 taken along line A-A as viewed in an arrow direction.

### DESCRIPTION OF THE PREFERRED EMBODIMENTS

Hereinafter, the solid-state battery according to the present disclosure will be described in detail. Although description will be made with reference to the drawings as necessary, the shown contents are only schematically and exemplarily illustrated for the understanding of the present disclosure, and the appearance, the dimensional ratio, and the like may be different from the actual ones.

The “sectional view” as used in the present description is based on a form (briefly, a form in the case of being cut along a plane parallel to the layer thickness direction) viewed from a direction substantially perpendicular to the stacking direction in the laminate structure of the solid-state battery. In addition, the “plan view” or “plan view shape” used in the present description is based on a sketch drawing when an object is viewed from an upper side or a lower side in the layer thickness direction (that is, the stacking direction mentioned above).

The “up-down direction” and “left-right direction” used directly or indirectly in the present description respectively correspond to the vertical direction and horizontal direction in the drawings. Unless otherwise specified, the same symbols or signs shall denote the same members or sites or the same meanings. In a preferred aspect, it can be understood that the downward direction in the vertical direction (that is, the direction in which gravity acts) corresponds to a “downward direction”, and the opposite direction corresponds to an “upward direction”.

The “solid-state battery” as used in the present disclosure refers to, in a broad sense, a battery whose constituent elements are solid, and refers to, in a narrow sense, an all-solid-state battery whose constituent elements (particularly preferably all constituent elements) are solid. In a preferred aspect, the solid-state battery in the present disclosure is a laminated solid-state battery configured such that respective layers constituting a battery constituent unit are laminated on each other, and such respective layers are preferably made of fired bodies. The “solid-state battery” is a so-called “secondary battery” that can be repeatedly charged and discharged. The “secondary battery” is not excessively restricted by its name, which can encompass, for example, a power storage device and the like.

A feature of the present disclosure relates to a positive electrode layer included in a solid-state battery. The basic configuration of a solid-state battery according to the present disclosure will be first described below for understanding the overall structure of the solid-state battery. However, the configuration of the solid-state battery described herein is merely an example for understanding the disclosure, and not considered limiting the disclosure.

### [Basic Configuration of Solid-State Battery]

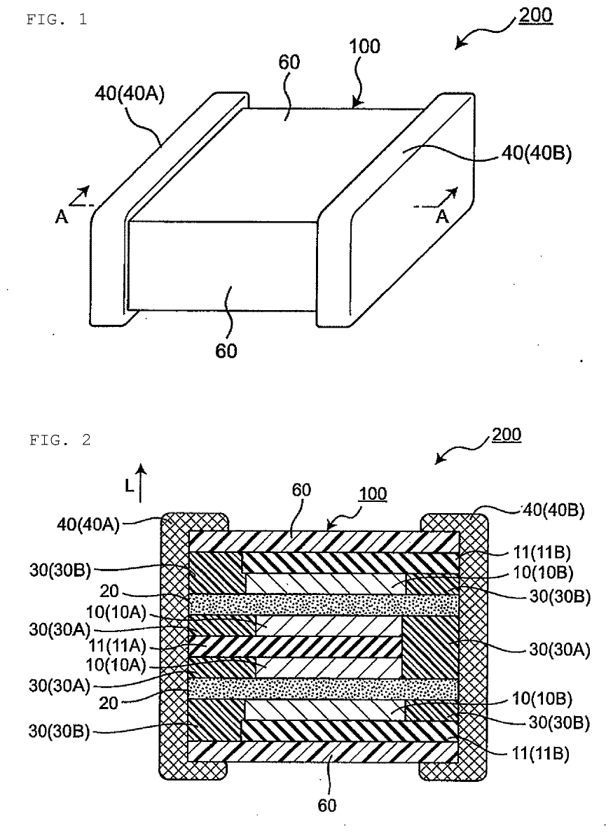

FIG. 1 is an external perspective view schematically showing a solid-state battery according to an embodiment of the present disclosure. FIG. 2 is a schematic sectional view of the solid-state battery in FIG. 1 taken along line A-A as viewed in an arrow direction. The solid-state battery includes at least electrode layers: a positive electrode and a negative electrode, and a solid electrolyte. Specifically, as shown in FIGS. 1 and 2, a solid-state battery 200 includes a solid-state battery laminate 100 including a battery constituent unit composed of a positive electrode layer 10A, a negative electrode layer 10B, and a solid electrolyte 20 at least interposed between the electrode layers.

The solid-state battery 200 according to the present disclosure includes: the solid-state battery laminate 100 including, in a stacking direction L, at least one battery constituent unit composed of the positive electrode layer 10A, the negative electrode layer 10B, and the solid electrolyte layer 20 interposed between the electrode layers; and a positive electrode terminal 40A and a negative electrode terminal 40B each provided on facing side surfaces of the solid-state battery laminate 100.

In the solid-state battery laminate 100, the positive electrode layer 10A and the negative electrode layer 10B are alternately laminated with the solid electrolyte layer 20 interposed therebetween.

For the solid-state battery, each of the layers constituting the solid-state battery may be formed by firing, and the positive electrode layer, the negative electrode layer, the solid electrolyte layer, and the like may form fired layers. Preferably, the positive electrode layer, the negative electrode layer, and the solid electrolyte layer are each fired integrally with each other, and the solid-state battery laminate preferably forms an integrally fired body.

The positive electrode layer is an electrode layer including at least a positive electrode active material. The positive electrode layer may further include a solid electrolyte. In a preferred aspect, the positive electrode layer is composed of a fired body including at least positive electrode active material particles and solid electrolyte particles. In contrast, the negative electrode layer is an electrode layer including at least a negative electrode active material. The negative electrode layer may further include a solid electrolyte. In a preferred aspect, the negative electrode layer is composed of a sintered body including at least negative electrode active material particles and solid electrolyte particles. The positive electrode layer that has such a configuration can be referred to as a “composite positive electrode body”, and similarly, the negative electrode layer may be referred to as a “composite negative electrode body”.

The positive electrode active material and the negative electrode active material are substances involved in the transfer of electrons in the solid-state battery. Ions move (conduct) between the positive electrode layer and the negative electrode layer through the solid electrolyte to transfer electrons, thereby charging and discharging the battery. Each electrode layer of the positive electrode layer and the negative electrode layer is preferably a layer capable of occluding and releasing lithium ions or sodium ions, in particular. More specifically, the solid-state battery is preferably an all-solid-state secondary battery in which lithium ions or sodium ions move between the positive electrode layer and the negative electrode layer through the solid electrolyte, thereby charging and discharging the battery.

Examples of the positive electrode active material included in the positive electrode layer include materials that can be selected from lithium-containing layered oxides, lithium-containing oxides that have a spinel-type structure, and the like. Examples of the lithium-containing layered oxides include LiCoO₂ and LiCo_{1/3}Ni_{1/3}Mn_{1/3}O₂. Examples of the lithium-containing oxides that have a spinel-type structure include LiMn₂O₄ and LiNi_{0.5}Mn_{1.5}O₄.

In addition, the positive electrode active material capable of occluding and releasing sodium ions can be selected from sodium-containing layered oxides, sodium-containing oxides that have a spinel-type structure, and the like.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, and may be, independently of each other, for example, 2 μm to 50 μm, particularly 5 μm to 30 μm.

### (Positive Electrode Current Collecting Layer/Negative Electrode Current Collecting Layer)

Although not an essential element for the electrode layer, the positive electrode layer and the negative electrode layer may respectively include a positive electrode current collecting layer 11A and a negative electrode current collecting layer 11B. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing.

As the positive electrode current collector constituting the positive electrode current collecting layer and the negative electrode current collector constituting the negative electrode current collector, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to a terminal.

It is to be noted that when the positive electrode current collecting layer and the negative electrode current collecting layer have the form of a fired body, the layers may be composed of a fired body including a conductive material and a sintering aid. The conductive materials included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as sintering aids that can be included in the positive electrode layer/the negative electrode layer.

### (Solid Electrolyte)

The solid electrolyte is a material capable of conducting lithium ions or sodium ions. The solid electrolyte can constitute a layer through which lithium ions can conduct between the positive electrode layer and the negative electrode layer. In addition, the solid electrolyte can also be included in the positive electrode layer and the negative electrode layer.

The solid electrolyte layer may include a sintering aid. The sintering aid included in the solid electrolyte layer may be selected from, for example, the same materials as the sintering aids that can be included in the positive electrode layer or the negative electrode layer.

The thickness of the solid electrolyte layer is not particularly limited. The thickness of the solid electrolyte layer located between the positive electrode layer and the negative electrode layer may be, for example, 1 μm to 15 μm, particularly 1 μm to 5 μm.

### (Electrode Separating Part)

The solid-state battery 200 according to the present disclosure may further include electrode separating parts (also referred to as “margin layers” or “margins”) 30 (30A, 30B).

The electrode separating part 30A (positive electrode separating part) is disposed around the positive electrode layer 10A, thereby separating the positive electrode layer 10A from the negative electrode terminal 40B. The electrode separating part 30B (negative electrode separating part) is disposed around the negative electrode layer 10B, thereby separating the negative electrode layer 10B from the positive electrode terminal 40A. Although not particularly limited, the electrode separating parts 30 may be composed of, for example, one or more materials selected from the group consisting of a solid electrolyte, an insulating material, a mixture thereof, and the like.

For the solid electrolyte that can constitute the electrode separating parts 30, the same material as the solid electrolyte that can constitute the solid electrolyte layer can be used.

The insulating material that can constitute the electrode separating parts 30 may be a material that does not conduct electricity, that is, a non-conductive material. Although not particularly limited, the insulating material may be, for example, a glass material, a ceramic material, or the like. For example, a glass material may be selected as the insulating material. The glass material is not particularly limited, and examples of the glass material include at least one selected from the group consisting of soda-lime glass, potash glass, borate-based glass, borosilicate-based glass, barium-borosilicate-based glass, zinc-borate-based glass, barium-borate-based glass, bismuth-borosilicate-based glass, bismuth-zinc-borate-based glass, bismuth-silicate-based glass, phosphate-based glass, aluminophosphate-based glass, and zinc-phosphate-based glass. In addition, the ceramic material is not particularly limited, and examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

### (Terminal)

The solid-state battery 200 according to the present disclosure is typically provided with terminals (external terminals) 40 (40A, 40B). In particular, the terminals 40A and 40B for positive and negative electrodes are provided so as to form a pair on side surfaces of the solid-state battery. More specifically, the terminal 40A on the positive electrode side connected to the positive electrode layer 10A and the terminal 40B on the negative electrode side connected to the negative electrode layer 10B are provided so as to form a pair. The terminals 40A and 40B can be provided so as to cover at least one side surface of the solid-state battery, and thus, can be referred to as “end face electrodes”. For such terminals 40 (40A, 40B), materials with high conductivity can be used. The material of the terminals 40 is not particularly limited, and examples thereof include at least one conductive material selected from the group consisting of silver, gold, platinum, aluminum, copper, tin, and nickel.

The terminals 40 (40A, 40B) may further include a sintering aid. Examples of the sintering aid include the same materials as the sintering aid that may be included in the positive electrode layer 10A. In a preferred embodiment, the terminals 40 (40A, 40B) are composed of a sintered body including at least the conductive material and the sintering aid.

### (Outer Layer Material)

The solid-state battery 200 according to the present disclosure typically further includes an outer layer material 60. The outer layer material 60 can be generally formed on the outermost side of the solid-state battery, and is intended for electrical, physical, and/or chemical protection. The material constituting the outer layer material 60 is preferably excellent in insulation property, durability, and/or moisture resistance, and environmentally safe. For example, glass, ceramics, thermosetting resins, photocurable resins, mixtures thereof, and the like can be used.

As glass that can constitute the outer layer material, the same material as the glass material that can constitute the electrode separating parts can be used. In addition, as a ceramic material that can constitute the outer layer material, the same material as the ceramic material that can constitute the electrode separating part can be used.

### [Features of Solid-State Battery According to Present Disclosure]

The inventors of the present application have intensively studied solutions for reducing the interface resistance between an active material and a solid electrolyte in a negative electrode layer of a solid-state battery. As a result, the inventors of the present application have newly devised the present disclosure that has technical features related to a specific combination of a negative electrode active material and a solid electrolyte in a negative electrode layer, and the density of the negative electrode active material and the content percentage of the solid electrolyte in specific ranges.

Specifically, the present disclosure has technical features in that the negative electrode layer includes a negative electrode active material including a Li composite oxide and an oxide glass-based solid electrolyte, furthermore, the content percentage of the solid electrolyte is 20% by mass to 60% by mass based on the total amount of the negative electrode active material and the solid electrolyte in the negative electrode layer, and the ratio (B/A) of the actual density B of the negative electrode active material to the true density A of the negative electrode active material is 0.3 to 0.6.

It is to be noted that “the negative electrode active material and the solid electrolyte in the negative electrode layer” in the present specification refers to a negative electrode active material and a solid electrolyte located in a region excluding voids, which can be formed in a negative electrode layer of a finally obtained solid-state battery (corresponding to a finished product).

According to the technical features mentioned above, when the content percentage of the solid electrolyte in the negative electrode layer is 20% by mass to 60% by mass, the actual density B of the negative electrode active material in the battery to the true density A of the negative electrode active material can be secured to meet a predetermined ratio (0.3 to 0.6). For example, the true density A of the negative electrode active material is 3.0 g/cm³ to 4.0 g/cm³, and can be 3.5 g/cm³ as an example. In addition, when the content percentage of the solid electrolyte in the negative electrode layer is 20% by mass or more, a predetermined amount of solid electrolyte is secured as compared with the case where the content is less than 20% by mass.

Thus, the contact interface between the negative electrode active material and the solid electrolyte in the negative electrode layer can be made dense, and the conduction path of lithium ions can be suitably formed. More specifically, the interface resistance between the negative electrode active material and the solid electrolyte in the negative electrode layer can be decreased to make lithium ions more likely to move across this interface. As a result, the internal resistance in the battery can be reduced, and the volume energy density can be improved.

In addition, when the content percentage of the solid electrolyte in the negative electrode layer is 60% by mass or less, the ratio (B/A) of the actual density B of the negative electrode active material to the true density A of the negative electrode active material can be secured to meet 0.3 or more as compared with the case where the content exceeds 60% by mass. Thus, in the battery prepared, since the negative electrode active material accounts for a predetermined amount in the negative electrode layer, the inter-particle distance of the negative electrode active material in the negative electrode layer can be kept a distance at which a preferred electronic path can be formed.

According to the foregoing, it is possible to secure a discharge capacity capable of achieving a charge-discharge efficiency that is equal to or more than a predetermined reference value (85% or more), and it is possible to improve the battery characteristics of the solid-state battery in a preferred manner.

The “true density of the negative electrode active material” in the present specification refers to a density that is intrinsic to a predetermined kind of negative electrode active material, and the “true density of the solid electrolyte” in the present specification refers to a density that is intrinsic to a predetermined kind of solid electrolyte. The true density of each of the negative electrode active material and the solid electrolyte can be calculated by a gas phase substitution method in which helium gas is used, and the true density can be calculated by changing the pressure and the volume to determine the volume of the measured object and then measuring the weight. In addition, the “actual density of the negative electrode active material” in the present specification refers to the volume density of the negative electrode active material in the negative electrode layer of the solid-state battery prepared.

The actual density B of the negative electrode active material after the battery preparation can be calculated with the use of the true density A of the negative electrode active material, the true density C of the solid electrolyte, the porosity E in the negative electrode, the content percentage F of the negative electrode active material in the negative electrode layer, and the content percentage G of the solid electrolyte. The calculation formulas for the calculation are as follows:

$$volume blending ratio ( V 1 ) of negative electrode active material = ( 100 - E ) \times F / A / ( F / A + G / C )$$

$$actual density ( B ) of negative electrode active material formed = ( A \times V 1 ) / 100$$

The porosity in the electrode can be calculated by ion-milling the obtained solid-state battery to form a smooth cross section and observing the cross section at a magnification of 5000 with the use of an SEM, and software referred to as Image J can be used in the calculation. In addition, the content percentage F of the negative electrode active material and the content percentage G of the solid electrolyte can also be calculated by the same method.

Further, in the present disclosure, the content percentage of the solid electrolyte is preferably 30% by mass to 50% by mass based on the total amount of the negative electrode active material and the solid electrolyte. In this case, the content percentage of the solid electrolyte in the negative electrode layer is increased by 10% by mass as compared with the case where the content percentage is 20% by mass, thereby allowing the contact interface between the negative electrode active material and the solid electrolyte in the negative electrode layer to be made denser, and allowing the conduction path of lithium ions to be formed in a more preferred manner.

When the content percentage of the solid electrolyte in the negative electrode layer is 50% by mass or less, the amount of the negative electrode active material is increased by 10% by mass as compared with the case where the content percentage is 60% by mass, thereby allowing the inter-particle distance of the negative electrode active material in the negative electrode layer to be kept a distance at which an electronic path can be formed in a more preferred manner. According to the foregoing, it is possible to secure a discharge capacity capable of achieving a charge-discharge efficiency that is equal to or more than a predetermined reference value (95% or more), and it is possible to improve the battery characteristics of the solid-state battery in a more preferred manner.

When the content percentage of the solid electrolyte is uniformly a predetermined amount (for example, 40% by mass) based on the total amount of the negative electrode active material and the solid electrolyte in the negative electrode layer, the ratio (C/A) of the true density C of the solid electrolyte to the true density A of the negative electrode active material can be 0.55 to 0.9. For example, the true density C of the solid electrolyte can be 2.0 g/cm³ to 3.0 g/cm³, preferably 2.0 g/cm³ to 2.5 g/cm³.

When the ratio C/A falls within this range, the actual density B of the negative electrode active material in the battery prepared can be secured to meet a predetermined ratio (0.3 to 0.6) to the true density A of the negative electrode active material. In contrast, when the ratio C/A falls outside this range (specifically, 0.51), the actual density B of the negative electrode active material in the battery prepared to the true density A of the negative electrode active material fails to be secured to meet a predetermined ratio (0.3 to 0.6).

As described above, in the battery prepared, the negative electrode active material (and the solid electrolyte) are secured in predetermined amounts in the negative electrode layer, thus allowing the contact interface between the negative electrode active material and the solid electrolyte in the negative electrode layer to be made dense, and allowing the conduction path of lithium ions to be formed in a preferred manner.

Furthermore, when the ratio C/A is 0.6 to 0.75, the ratio B/A can be 0.35 to 0.5. In this case, the ratio B/A can be increased as compared with the case where the ratio C/A is less than 0.6. Accordingly, in the battery prepared, the negative electrode active material (and the solid electrolyte) are secured in predetermined amounts in the negative electrode layer in a more preferred manner, thus allowing the contact interface between the negative electrode active material and the solid electrolyte in the negative electrode layer to be made denser, and allowing the conduction path of lithium ions to be formed in a more preferred manner.

The Li composite oxide included in the negative electrode active material can be an oxide containing Li and a transition metal element, and as an example, can be an oxide containing Li and at least one metal element selected from the group consisting of titanium (Ti), silicon (Si), tin (Sn), chromium (Cr), iron (Fe), niobium (Nb), and molybdenum (Mo). For example, the Li composite oxide included in the negative electrode active material can be an oxide containing Li and Ti. When an oxide containing Li and Ti is used, a high energy density can be obtained while keeping the negative electrode layer from expanding or shrinking at the time of charging and discharging.

The oxide glass-based solid electrolyte of the negative electrode layer is advantageous in that the solid electrolyte can contribute to reducing the porosity in the negative electrode, and can be, for example, lithium borosilicate glass. The lithium borosilicate glass is an oxide-based glass material containing at least lithium (Li), silicon (Si), and boron (B) as constituent elements, and can be, for example, 50Li₄SiO₄-50Li₃BO₃. The lithium borosilicate glass can be advantageous in that the glass has a low glass transition temperature and is capable of forming a dense negative electrode layer.

In addition, the solid electrolyte may further include a solid electrolyte for use in other known solid-state batteries, in addition to the lithium borosilicate glass as a glass-based solid electrolyte. Such a solid electrolyte may be, for example, any one type, or two or more types of a crystalline solid electrolyte, a glass-based solid electrolyte that is different from the lithium borosilicate glass, a glass ceramic-based solid electrolyte, and the like. Examples of the crystalline solid electrolyte include oxide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors.

Examples of the lithium-containing phosphate compounds that have a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. Examples of the oxide having a perovskite structure include La_{0.55}Li_{0.35}TiO₃. Examples of the oxides that have a garnet-type or garnet-type similar structure include Li₇La₃Zr₂O₁₂. The crystalline solid electrolyte may include a polymer material (for example, a polyethylene oxide (PEO)).

Examples of the glass-based solid electrolyte that can be employed other than the lithium borosilicate glass include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. In addition, LAGP is, for example, Li_{1.5}Al_{0.5}Ge_{1.5}(PO₄).

For example, the solid electrolyte may further include, from the viewpoint of improving the ionic conductivity, an oxide that has a garnet-type or garnet-type similar structure in addition to the lithium borosilicate glass.

### [Method for Manufacturing Solid-State Battery]

The solid-state battery according to the present disclosure can be manufactured by a printing method such as a screen printing method, a green sheet method in which green sheets are used, or a combined method thereof. Hereinafter, a case where the printing method and the green sheet method are employed for understanding the present disclosure will be described in detail, but the present disclosure is not limited to the methods. More specifically, the solid-state battery may be manufactured in accordance with a common method for manufacturing a solid-state battery. In addition, the following time-dependent matters such as the order of descriptions are merely considered for convenience of explanation, and the present disclosure is not necessarily bound by the matters.

### (Step of Forming Solid-State Battery Laminate Precursor)

In the present step, for example, several types of pastes are used as inks, such as a positive electrode layer paste, a negative electrode layer paste, a solid electrolyte layer paste, a positive electrode current collecting layer paste, a negative electrode current collecting layer paste, an electrode separating part paste, and an outer layer material paste. More specifically, a solid-state battery laminate precursor that has a predetermined structure is formed on a supporting substrate by applying and drying the pastes in accordance with the printing method.

In printing, a solid-state battery laminate precursor corresponding to the structure of a predetermined solid-state battery can be formed on a substrate by sequentially stacking printing layers that each have a predetermined thickness and a pattern shape. The type of the pattern forming method is not particularly limited as long as the method is a method capable of forming a predetermined pattern, and is, for example, any one or two or more of a screen printing method a gravure printing method, and the like.

The paste can be prepared by wet mixing of predetermined constituent materials for each of the layers, appropriately selected from the group consisting of positive electrode active material particles, negative electrode active material particles, a conductive material, a solid electrolyte material, a current collecting layer material, an insulating material, a sintering aid, and the other materials mentioned above with an organic vehicle in which an organic material is dissolved in a solvent.

The positive electrode layer paste includes, for example, the positive electrode active material particles, the solid electrolyte material, an organic material, a solvent, and optionally a sintering aid.

The negative electrode layer paste includes, for example, the negative electrode active material particles, the solid electrolyte material, an organic material, a solvent, and optionally a sintering aid.

The solid electrolyte layer paste includes, for example, the solid electrolyte material, an organic material, a solvent, and optionally a sintering aid.

The positive electrode current collecting layer paste includes a conductive material, an organic material, a solvent, and optionally a sintering aid.

The negative electrode current collecting layer paste includes a conductive material, an organic material, a solvent, and optionally a sintering aid.

The electrode separating part paste includes, for example, the solid electrolyte material, an insulating material, an organic material, a solvent, and optionally a sintering aid.

The outer layer material paste includes, for example, an insulating material, an organic material, a solvent, and optionally a sintering aid.

The organic material included in the paste is not particularly limited, and at least one polymer material selected from the group consisting of a polyvinyl acetal resin, a cellulose resin, a polyacrylic resin, a polyurethane resin, a polyvinyl acetate resin, a polyvinyl alcohol resin, and the like can be used.

The type of the solvent is not particularly limited, and the solvent is, for example, any one, or two or more of organic solvents such as butyl acetate, N-methyl-pyrrolidone, toluene, terpineol, and N-methyl-pyrrolidone.

In the wet mixing, a medium can be used, and specifically, a ball mill method, a Visco mill method, or the like can be used. In contrast, a wet mixing method without any medium used may be used, and a sand mill method, a high-pressure homogenizer method, a kneader dispersion method, or the like can be used.

The supporting substrate is not particularly limited as long as the supporting substrate is a support that is capable of supporting each paste layer, and the supporting substrate is, for example, a release film that has one surface subjected to a release treatment, or the like. Specifically, a substrate formed from a polymer material such as a polyethylene terephthalate can be used. When the paste layer is subjected to a firing step with the paste layer held on the substrate, a substrate with heat resistance to the firing temperature may be used.

Alternatively, a solid-state battery laminate precursor can also be prepared by forming each green sheet from each of the pastes, and stacking the obtained green sheets.

Specifically, a supporting substrate with each paste applied thereto is dried on a hot plate heated to 30° C. or higher and 90° C. or lower to form, on each supporting substrate (for example, a PET film), each green sheet such as a positive electrode layer green sheet, a negative electrode layer green sheet, a solid electrolyte layer green sheet, a positive electrode current collecting layer green sheet, a negative electrode current collecting layer green sheet, an electrode separating part green sheet, and/or an outer layer material green sheet, which has predetermined shape and thickness.

Next, each green sheet is peeled off from the substrate. After the peeling, the green sheets for respective constituent elements are sequentially stacked in the stacking direction to form a solid-state battery laminate precursor. After the stacking, a solid electrolyte layer, an insulating layer and/or a protective layer may be provided by screen printing in a side region of the electrode green sheet.

### (Firing Step)

In the firing step, the solid-state battery laminate precursor is subjected to firing. By way of example only, the firing is carried out by heating in a nitrogen gas atmosphere containing oxygen gas or in the atmosphere, for example, at 200° C. or higher to remove the organic material, and then heating in the nitrogen gas atmosphere or in the atmosphere, for example, at 300° C. or higher and 500° C. or lower. The firing may be carried out while applying a pressure to the solid-state battery laminate precursor at 20 to 100 MPa in the stacking direction (in some cases, the stacking direction and a direction perpendicular to the stacking direction).

By undergoing such firing, a solid-state battery laminate is formed, and a desired solid-state battery is finally obtained.

### (Step of Forming Positive Electrode Terminal and Negative Electrode Terminal)

For example, a positive electrode terminal is bonded to the solid-state battery laminate with the use of a conductive adhesive, and a negative electrode terminal is bonded to the solid-state battery laminate with the use of a conductive adhesive. Thus, each of the positive electrode terminal and the negative electrode terminal is attached to the solid-state battery laminate. As a result, a desired solid-state battery can be finally obtained.

While the embodiment of the present disclosure has been described above, a typical example has been merely illustrated. Accordingly, the present disclosure is not limited to the embodiment, and those skilled in the art will readily understand that various aspects are conceivable without changing the spirit of the present disclosure.

### EXAMPLES

Hereinafter, examples will be described.

### Example 1

### (Step of Preparing Solid Electrolyte Layer Green Sheet)

First, halogen-containing lithium borosilicate glass (obtained by substituting 10% of O in 60Li₂O-10SiO₂-30B₂O₃ with Cl) as a solid electrolyte and an acrylic binder were mixed at a mass ratio of lithium borosilicate glass:acrylic binder=70:30. The true density of the solid electrolyte used in Example 1 was 2.5 g/cm³.

Next, the obtained mixture was mixed with a butyl acetate as a solvent such that the solid content was 30% by mass, and then, this mixture was stirred with zirconia balls of 5 mm in diameter for 4 hours to obtain a solid electrolyte layer paste. Subsequently, this paste was applied onto a release film and dried at 80° C. for 20 minutes to prepare a solid electrolyte layer green sheet as a solid electrolyte layer precursor.

### (Step of Preparing Positive Electrode Material Layer Green Sheet)

First, a lithium cobalt oxide (LiCoO₂) was prepared. Next, the LiCoO₂ as a positive electrode active material, the solid electrolyte used for the solid electrolyte layer green sheet mentioned above as a solid electrolyte, and an acrylic binder were mixed at a mass ratio of LiCoO₂:solid electrolyte:binder=70:20:10. Next, the obtained mixture was mixed with terpineol such that the solid content was 60% by mass. Then, the obtained mixture was stirred with zirconia balls of 5 mm in diameter for 1 hour to obtain a positive electrode material layer paste. Subsequently, this paste was applied onto a release film and dried at 80° C. for 20 minutes to prepare a positive electrode material layer green sheet as a positive electrode layer precursor.

### (Step of Preparing Negative Electrode Material Layer Green Sheet)

First, Li₄Ti₅O₁₂ (manufactured by Merck, product number: 915939) as a negative electrode active material, the solid electrolyte used for the solid electrolyte layer green sheet mentioned above as a solid electrolyte, and an acrylic binder were mixed at a mass ratio of Li₄Ti₅O₁₂:solid electrolyte:binder=72:18:10.

The true density of the negative electrode active material used was 3.5 g/cm³.

Next, the obtained mixture was mixed with terpineol such that the solid content was 60% by mass. Then, the obtained mixture was stirred with zirconia balls of 5 mm in diameter for 1 hour to obtain a negative electrode material layer paste. Subsequently, this paste was applied onto a release film and dried at 80° C. for 20 minutes to prepare a negative electrode material layer green sheet as a negative electrode material layer precursor.

### (Step of Preparing Positive Electrode Current Collecting Layer Green Sheet)

First, a carbon powder (product number: VGCF (registered trademark) -F manufactured by Resonac Corporation) as a conductive material, the solid electrolyte used for the solid electrolyte layer green sheet mentioned above as a solid electrolyte, and an acrylic binder were mixed at a mass ratio of carbon powder:solidelectrolyte:binder=70:20:10. Next, the obtained mixture was mixed with terpineol such that the solid content was 60% by mass. Then, the obtained mixture was stirred with zirconia balls of 5 mm in diameter for 1 hour to obtain a positive electrode current collecting layer paste. Subsequently, this paste was applied onto a release film and dried at 80° C. for 20 minutes to prepare a positive electrode current collecting layer green sheet as a positive electrode current collecting layer precursor.

### (Step of Preparing Negative Electrode Current Collecting Layer Green Sheet)

A negative electrode current collecting layer green sheet was prepared in the same manner as in the above-described step of preparing a positive electrode current collecting layer green sheet.

### (Step of Preparing Outer Layer Material Green Sheet)

First, an alumina particle powder (product number: γ-Al₂O₃alumina, manufactured by Kojundo Chemical Laboratory Co., Ltd.) as a particle powder, the solid electrolyte used for the solid electrolyte layer green sheet mentioned above as a solid electrolyte, and an acrylic binder were mixed at a mass ratio of carbon powder:solidelectrolyte:binder=70:20:10. Next, the obtained mixture was mixed with terpineol such that the solid content was 60% by mass. Then, the obtained mixture was stirred with zirconia balls of 5 mm in diameter for 1 hour to obtain an outer layer material paste. Subsequently, this paste was applied onto a release film and dried to prepare an outer layer material green sheet as an outer layer material precursor.

### (Step of Preparing Electrode Separating Part Green Sheet)

An electrode separating part green sheet as an electrode separating part precursor was prepared in the same manner as in the above-described step of preparing an outer layer material green sheet.

### (Step of Preparing Laminate)

With the use of the respective green sheets obtained as described above, a laminate with the configuration shown in FIGS. 1 and 2 was prepared as follows. Specifically, first, each of the green sheets was processed into the shape shown in FIGS. 1 and 2, and then released from the release film. Subsequently, the respective green sheets were sequentially stacked so as to correspond to the configuration of the battery element shown in FIGS. 1 and 2, and then subjected to thermocompression bonding by heating to 100° C. while applying a pressure in the thickness direction. As a result, a laminate as a battery element precursor was obtained.

### (Step of Degreasing and Sintering for Laminate)

The obtained laminate was heated at 300° C. for 10 hours to remove the acrylic binder included in each of the green sheets, and then, the laminate with the acrylic binder removed therefrom was heated at 350° C. for 10 minutes while applying a pressure in the thickness direction under the condition of 20 to 100 MPa, and then cooled in the atmosphere for 1 hour to obtain a sintered laminate.

### (Step of Preparing Terminal)

Next, a silver plate is bonded to first and second end surfaces (or side surfaces) of the laminate, at which the positive electrode collecting layer and the negative electrode collecting layer were exposed respectively, with the use of a conductive adhesive (thermosetting silver paste) to form positive and negative electrode terminals, thereby preparing a solid-state battery.

In addition to or in place of the above-mentioned steps of preparing the laminate, and degreasing and sintering, the multiple solid electrolyte layer green sheets obtained by punching with a diameter of φ16 mm and the negative electrode material layer green sheets obtained by punching with a diameter of 08 mm were sequentially attached onto SUS304 (φ16 mm, 0.3 mm in thickness). Thereafter, the binder included in the green sheets was subjected to degreasing at 300° C. with the use of a muffle furnace KDF P-90 (manufactured by Denken Co., Ltd.). The degreased sample was heated at 350° C. for 10 minutes while applying a pressure in the thickness direction under the condition of 20 to 100 MPa in a pressure sintering machine P-5058-00 (manufactured by NPa System CO., LTD.), and then cooled in the atmosphere for 30 minutes to be sintered, thereby providing a cell element. Thereafter, a Li foil of 100 μm in thickness was subjected to punching with a diameter of φ10 mm and attached to the cell element to prepare a half cell used for the present evaluation. Further, in the prepared cell, the content ratio between the negative electrode active material and the solid electrolyte on a mass basis was 80:20 with the acrylic binder removed.

### Example 2

In Example 2, the Li₄Ti₅O₁₂, the solid electrolyte, and the binder were mixed at a mass ratio of Li₄Ti₅O₁₂:solid electrolyte:binder=63:27:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 70:30 with the acrylic binder removed.

### Example 3

In Example 3, the Li₄Ti₅O₁₂, the solid electrolyte, and the binder were mixed at a mass ratio of Li₄Ti₅O₁₂:solid electrolyte:binder=54:36:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 60:40 with the acrylic binder removed.

### Example 4

In Example 4, the Li₄Ti₅O₁₂, the solid electrolyte, and the binder were mixed at a mass ratio of Li₄Ti₅O₁₂:solid electrolyte:binder=45:45:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 50:50 with the acrylic binder removed.

### Example 5

In Example 5, the Li₄Ti₅O₁₂, the solid electrolyte, and the binder were mixed at a mass ratio of Li₄Ti₅O₁₂:solid electrolyte:binder=36:54:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 40:60 with the acrylic binder removed.

### Example 6

In Example 6, the Li₄Ti₅O₁₂, the solid electrolyte, and the binder were mixed at a mass ratio of Li₄Ti₅O₁₂:solid electrolyte:binder=54:36:10 in the step of preparing a negative electrode material layer green sheet as in Example 3. More specifically, in the prepared cell, the content ratio between the negative electrode active material and the solid electrolyte on a mass basis was 60:40 with the acrylic binder removed. In contrast, unlike Example 3, the composition ratios of Li, B, and Si constituents, which are main constituents of the solid electrolyte, or the like are adjusted in Example 6. For example, a solid electrolyte with a true density of 2.2 g/cm³ was used, which was obtained by decreasing the content ratio of Si.

### Example 7

In Example 7, the Li₄Ti₅O₁₂, the solid electrolyte, and the binder were mixed at a mass ratio of Li₄Ti₅O₁₂:solid electrolyte:binder=54:36:10 in the step of preparing a negative electrode material layer green sheet as in Example 3. More specifically, in the prepared cell, the content ratio between the negative electrode active material and the solid electrolyte on a mass basis was 60:40 with the acrylic binder removed. In contrast, in Example 7, unlike Example 3, a solid electrolyte with a true density of 2.0 g/cm³ was used, which was obtained by adjusting the composition ratios of Li, B, and Si constituents which were main constituents of the solid electrolyte, or the like, for example, by further reducing the content ratio of Si.

### Comparative Example 1

In Comparative Example 1, the Li₄Ti₅O₁₂, the solid electrolyte, and the binder were mixed at a mass ratio of Li₄Ti₅O₁₂:solid electrolyte:binder=81:9:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 90:10 with the acrylic binder removed.

### Comparative Example 2

In Comparative Example 2, the Li₄Ti₅O₁₂, the solid electrolyte, and the binder were mixed at a mass ratio of Li₄Ti₅O₁₂:solid electrolyte:binder=27:63:10 in the step of preparing a negative electrode material layer green sheet in Example 1. Except for this point, a solid-state battery was produced in the same manner as in Example 1. Further, in the prepared cell, the content ratio between the negative electrode active material and the solid electrolyte on a mass basis was 30:70 with the acrylic binder removed.

### Comparative Example 3

In Comparative Example 3, the Li₄Ti₅O₁₂, the solid electrolyte, and the binder were mixed at a mass ratio of Li₄Ti₅O₁₂:solid electrolyte:binder=54:36:10 in the step of preparing a negative electrode material layer green sheet as in Example 3. More specifically, in the prepared cell, the content ratio between the negative electrode active material and the solid electrolyte on a mass basis was 60:40 with the acrylic binder removed. In contrast, in Comparative Example 3, unlike Example 3, a solid electrolyte with a true density of 1.8 g/cm³ was used, which was obtained by adjusting the composition ratios of Li, B, and Si constituents which were main constituents of the solid electrolyte, or the like, for example, by further reducing the content ratio of Si.

### [Measurement Contents]

### (Measurement of Battery Characteristics)

The half cell was placed in a low temperature thermostat (manufactured by Yamato Scientific Co., Ltd., model number: IQ822), and then subjected to a charge-discharge test with the use of a charge-discharge evaluation apparatus (manufactured by TOYO SYSTEM CO., LTD., model number: TOSCAT-3100). The charge-discharge conditions were as follows. The rated capacity of the cell was set to 1 C, and the cell was charged to a predetermined potential at a constant current of 0.05 C (cutoff voltage: 4 V). In addition, the half cell was discharged to a predetermined potential at a constant current of 0.05 C, and after reaching the predetermined potential, discharged in a constant voltage mode until the current was reduced to 0.005 C (cutoff voltage: 1.0 V). The charge-discharge capacity of the half cell was checked with such a charge-discharge test.

### [Measurement Results 1]

Table 1 shows the measurement results on Examples 1 to 5 and Comparative Examples 1 and 2. In these examples and comparative examples, the charge capacity was about 170 mAh/g. With this value as a reference, the charge-discharge efficiency was calculated from the ratio of the discharge capacity to the charge capacity. The half cell with the charge-discharge efficiency of 85% or more was rated as o, the half cell with the charge-discharge efficiency of 95% or more was rated ⊚, and the half cell with the charge-discharge efficiency of less than 85% or the half cell for which the discharge capacity failed to be measured was rated as x.

TABLE 1

| | | | | Actual Density | | |
|---|---|---|---|---|---|---|
| | | True Density | | B of Negative | | |
| | | A of Negative | True | Electrode | | |
| | Content Ratio | Electrode | Density C | Active | | |
| | of Active | Active | of Solid | Material after | Discharge | |
| | Material:Elec- | Material | Electrolyte | Preparation | Capacity | |
| | trolyte | (g/cm³) | (g/cm³) | (g/cm³) | (mAh/g) | Determination |
| Comparative | 90:10 | 3.5 | 2.5 | ⅔ × A | Unmeasurable | X |
| Example 1 | | | | | | |
| Example 1 | 80:20 | 3.5 | 2.5 | ⅓ × A | 150 | ◯ |
| Example 2 | 70:30 | 3.5 | 2.5 | ⅓ × A | 162 | ⊙ |
| Example 3 | 60:40 | 3.5 | 2.5 | ⅖ × A | 168 | ⊙ |
| Example | 50:50 | 3.5 | 2.5 | ⅖ × A | 163 | ⊙ |
| Example 5 | 40:60 | 3.5 | 2.5 | ⅖ × A | 151 | ◯ |
| Comparative | 30:70 | 3.5 | 2.5 | ⅙ × A | 120 | X |
| Example 2 | | | | | | |

As shown in Example 1 to Example 5 in Table 1, it has been determined that in the obtained battery, the charge-discharge efficiency is 85% or more, when the content ratio (on a mass basis) between the negative electrode active material and the solid electrolyte is 80:20 to 40:60, that is, the content percentage of the solid electrolyte is 20% by mass to 60% by mass based on the total amount of the negative electrode active material and the solid electrolyte, and when the ratio (B/A) of the actual density B of the negative electrode active material to the true density A of the negative electrode active material is 0.3 to 0.6.

In particular, it has been determined that the charge-discharge efficiency is 95% or more when the content ratio between the negative electrode active material and the solid electrolyte is 70:30 to 50:50, that is, when the content percentage of the solid electrolyte is 30% by mass to 50% by mass based on the total amount of the negative electrode active material and the solid electrolyte. The density of the negative electrode active material B after preparation in this case was 0.3 g/cm³ to 0.5 g/cm³.

In contrast, as shown in Comparative Example 1, when the mass content ratio between the negative electrode active material and the solid electrolyte was 90:10, that is, the content percentage of the solid electrolyte was 10% by mass based on the total amount of the negative electrode active material and the solid electrolyte, and when the porosity in the negative electrode layer was 20.0% by volume or less, a battery could be prepared, but the discharge capacity could not be measured. From the foregoing, it has been determined that due to the high content percentage of the negative electrode active material and the low content percentage of the solid electrolyte, the contact interface between the negative electrode active material and the solid electrolyte fails to be made dense, thereby causing the conduction path of lithium ions to fail to be formed.

In addition, as shown in Comparative Example 2, it has been determined that the charge-discharge efficiency is less than 85%, when the mass content ratio between the negative electrode active material and the solid electrolyte is 30:70, that is, the content percentage of the solid electrolyte is 70% by mass based on the total amount of the negative electrode active material and the solid electrolyte, and when the ratio (B/A) of the actual density B of the negative electrode active material to the true density A of the negative electrode active material is less than 0.3. From the foregoing, it has been determined that the inter-particle distance of the negative electrode active material fails to be kept a distance at which an electronic path can be formed, when the content percentage of the solid electrolyte in the negative electrode layer exceeds 60% by mass with the ratio (B/A) less than 0.3.

From the foregoing, it has been determined that in the above-mentioned ranges of Examples 1 to 5: the contact interface between the negative electrode active material and the solid electrolyte can be made dense; the conduction path of lithium ions can be formed in a preferred manner; and the inter-particle distance of the negative electrode active material in the negative electrode layer can be kept a distance at which a preferred electronic path can be formed.

### [Measurement Results 2]

Table 2 shows the measurement results on Example 3, Example 6, Example 7, and Comparative Example 3. Also in these examples and comparative example, as in Example 1 and the like, the charge capacity was about 170 mAh/g, and with this value as a reference, the charge-discharge efficiency was calculated from the ratio of the discharge capacity to the charge capacity. The half cell with the charge-discharge efficiency of 85% or more was rated as o, the half cell with the charge-discharge efficiency of 95% or more was rated ⊚, and the half cell with the charge-discharge efficiency of less than 85% or the half cell for which the discharge capacity failed to be measured was rated as x.

TABLE 2

| | | True Density | | Actual Density | | |
|---|---|---|---|---|---|---|
| | | A of Negative | | B of Negative | | |
| | Content Ratio | Electrode | True Density | Electrode | | |
| | of Active | Active | C of Solid | Active | Discharge | |
| | Material:Elec- | Material | Electrolyte | Material Formed | Capacity | |
| | trolyte | (g/cm³) | (g/cm³) | (g/cm³) | (mAh/g) | Determination |
| Example 3 | 60:40 | 3.5 | 2.5 | ⅖ × A | 168 | ⊙ |
| Example 6 | 60:40 | 3.5 | 2.2 | ⅖ × A | 165 | ⊙ |
| Example 7 | 60:40 | 3.5 | 2.0 | ⅓ × A | 154 | ◯ |
| Comparative | 60:40 | 3.5 | 1.8 | ⅕ × A | 125 | X |
| Example 2 | | | | | | |

As shown in Examples 3, 6 and 7 in Table 2, it has been determined that in the obtained battery: the ratio B/A is 0.3 to 0.5; and the charge-discharge efficiency is secured to meet 85% or more, when the ratio (C/A) of the true density C of the solid electrolyte to the true density A of the negative electrode active material is 0.55 to 0.9 when the content ratio between the negative electrode active material and the solid electrolyte is uniformly 60:40, that is, the content percentage of the solid electrolyte is uniformly 40% by mass based on the total amount of the negative electrode active material and the solid electrolyte. In particular, as shown in Example 3 and Example 6, it has been determined that when the ratio C/A is 0.6 to 0.75, the ratio B/A is 0.35 to 0.5, and the charge-discharge efficiency is secured to meet 95% or more. In contrast, it has been found that when the ratio (C/A) is less than 0.55, the ratio B/A is less than 0.3, and the charge-discharge efficiency is less than 85%.

From the foregoing, it has been found that in a case where the solid electrolyte is included in a predetermined amount based on the total amount of the negative electrode active material and the solid electrolyte in the negative electrode layer, the ratio (C/A) of the true density C of the solid electrolyte to the true density A of the negative electrode active material is also related to the charge-discharge efficiency, that is, the battery characteristics.

The solid-state battery according to the present disclosure can be used in various fields in which electricity storage is expected. Although the followings are merely examples, the solid-state battery of the present disclosure can be used in electricity, information and communication fields where mobile equipment and the like are used (e.g., electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines).

### DESCRIPTION OF REFERENCE SYMBOLS

10: Electrode layer
10A: Positive electrode layer
10B: Negative electrode layer
11: Electrode current collecting layer
11A: Positive electrode current collecting layer
11B: Negative electrode current collecting layer
20: Solid electrolyte layer
30: Electrode separating part
30A: Positive electrode separating part
30B: Negative electrode separating part
40: Terminal
40A: Positive electrode terminal
40B: Negative electrode terminal
60: Outer layer material
100: Solid-state battery laminate
200: Solid-state battery

1. A solid-state battery comprising:
a negative electrode layer including:
a negative electrode active material including a first Li composite oxide; and
an oxide glass-based solid electrolyte,
wherein a content percentage of the oxide glass-based solid electrolyte based on a total amount of the negative electrode active material and the oxide glass-based solid electrolyte in the negative electrode layer is 20% by mass to 60% by mass, and
a ratio (B/A) of an actual density B of the negative electrode active material to a true density A of the negative electrode active material is 0.3 to 0.6.

2. The solid-state battery according to claim 1, wherein the content percentage of the oxide glass-based solid electrolyte is 30% by mass to 50% by mass.

3. The solid-state battery according to claim 2, wherein a ratio (C/A) of a true density C of the oxide glass-based solid electrolyte to the true density A of the negative electrode active material is 0.55 to 0.9.

4. The solid-state battery according to claim 3, wherein when the ratio (C/A) is 0.6 to 0.75, and the ratio (B/A) is 0.35 to 0.5.

5. The solid-state battery according to claim 1, wherein a ratio (C/A) of a true density C of the oxide glass-based solid electrolyte to the true density A of the negative electrode active material is 0.55 to 0.9.

6. The solid-state battery according to claim 5, wherein when the ratio (C/A) is 0.6 to 0.75, and the ratio (B/A) is 0.35 to 0.5.

7. The solid-state battery according to claim 1, wherein the true density A of the negative electrode active material is 3.0 g/cm³ to 4.0 g/cm³.

8. The solid-state battery according to claim 2, wherein the true density A of the negative electrode active material is 3.0 g/cm³ to 4.0 g/cm³.

9. The solid-state battery according to claim 3, wherein the true density A of the negative electrode active material is 3.0 g/cm³ to 4.0 g/cm³.

10. The solid-state battery according to claim 5, wherein the true density A of the negative electrode active material is 3.0 g/cm³ to 4.0 g/cm³.

11. The solid-state battery according to claim 3, wherein the true density C of the oxide glass-based solid electrolyte is 2.0 g/cm³ to 3.0 g/cm³.

12. The solid-state battery according to claim 5, wherein the true density C of the oxide glass-based solid electrolyte is 2.0 g/cm³ to 3.0 g/cm³.

13. The solid-state battery according to claim 1, wherein the first Li composite oxide is an oxide containing Li and a transition metal element.

14. The solid-state battery according to claim 13, wherein the transition metal element is Ti.

15. The solid-state battery according to claim 1, wherein the oxide glass-based solid electrolyte is lithium borosilicate glass.

16. The solid-state battery according to claim 1, further comprising a positive electrode layer, wherein the positive electrode layer includes:
a positive electrode active material including a second Li composite oxide, and
the oxide glass-based solid electrolyte.

17. The solid-state battery according to claim 16, wherein the second Li composite oxide is an oxide containing Li and Co.
